(19) United States
(12) Patent Application Publication
(10) Pub. No.: US 2025/0336593 A1
(43) Pub. Date: Oct. 30, 2025

(54) Coil Component

(71) Applicant: SUMIDA CORPORATION, Tokyo (JP)

(72) Inventors: Masami TANIFUJI, Natori City (JP); Kaito SUZUKI, Natori City (JP); Tomomi UJIIE, Natori City (JP)

(21) Appl. No.: 19/260,198

(22) Filed: Jul. 3, 2025

Related U.S. Application Data
(63) Continuation of application No. PCT/JP2023/004980, filed on Feb. 14, 2023.

(51) Int. Cl. H01F 27/29; H01F 27/02; H01F 27/28; H01F 27/32

(52) U.S. Cl. CPC H01F 27/29; H01F 27/02; H01F 27/2828; H01F 27/325

(57) ABSTRACT

A coil component includes a base portion, a terminal that protrudes from a lower surface of the base portion, and a coil that is electrically connected to the terminal. The lower surface of the base portion includes a lowermost portion that is positioned furthest downward and a protruding surface that is positioned above the lowermost portion. The terminal includes an embedded portion, a protruding portion, a bent portion, and a mounting portion. The embedded portion is embedded in the base portion. The protruding portion is continuous from the embedded portion, protrudes downward from the protruding surface, and has a linear shape. The bent portion is continuous from the protruding portion and is bent toward a side of the base portion. The mounting portion includes a mounting surface that faces downward and the mounting portion is continuous from the bent portion.

### CROSS REFERENCE TO RELATED APPLICATIONS

This application claims priority to International Patent Application No. PCT/JP2023/004980, filed on Feb. 14, 2023, which is expressly incorporated herein by reference in its entirety.

### BACKGROUND

### Technical Field

The present invention relates to a coil component.

### BACKGROUND ART

Some coil components include a terminal protrudes from a lower surface of a base portion with insulation properties. With regard to this type of technology, Japanese Patent Laid-Open No. 2020-126909 (Patent Document 1) discloses a coil component (100) in which a terminal protrusion hole (45) open downward is provided on a lower surface (40a) of an insulating frame body (24) and an electrode terminal member (47) protrudes downward from the terminal protrusion hole (45). In addition, the electrode terminal member (47) includes a mounting terminal (50) at one end thereof. The coil component (100) is mounted on a substrate with a lower surface of the mounting terminal (50) in contact with the substrate.

The insulating frame body (24) in the coil component (100) according to Patent Document 1 is generally formed by injection molding. In other words, the electrode terminal member (47) is arranged in a mold corresponding to an outer shape of the insulating frame body (24) and liquid resin or the like is fed into the mold. More specifically, a shape of the mold corresponds to a shape of a portion of the electrode terminal member (47) that is to protrude from the insulating frame body (24) as well as a top wall and a peripheral wall of the terminal protrusion hole (45). A surface of the mold and an outer surface of the electrode terminal member (47) are arranged to be aligned and the liquid resin flows into the mold so that a part of the electrode terminal member (47) is embedded.

When resin is poured into the mold, if there is a gap between the outer surface of the electrode terminal member (47) and a corresponding mold surface, the resin may enter the gap and spread along the electrode terminal member (47) to cover a part of a mounting surface that is the lower surface of the mounting terminal (50). When a part of the mounting surface is covered with resin, contact between the mounting terminal (50) and the substrate is likely to be poor, which is undesirable.

The present invention has been made in view of the above-mentioned problem and provides a coil component having a structure that can suppress an amount of resin that leaks out of a mold during injection molding. This problem is not limited to resins but also occurs with other raw materials used in injection molding.

### SUMMARY

The coil component according to the present invention includes: a base portion; a terminal that protrudes from a lower surface of the base portion; and a coil that is electrically connected to the terminal, wherein the lower surface of the base portion includes a lowermost portion that is positioned furthest downward and a protruding surface that is positioned above the lowermost portion, and the terminal has an embedded portion that is embedded in the base portion, a protruding portion that is continuous from the embedded portion, protrudes downward from the protruding surface, and has a linear shape, a bent portion that is continuous from the protruding portion and is bent toward a side of the base portion, and a mounting portion that is continuous from the bent portion and includes a mounting surface facing downward.

In the coil component according to the present invention, the protruding portion that protrudes from the protruding surface has a linear shape. When the protruding portion has a linear shape, a mold can be aligned with the protruding portion during injection molding and the gap between the mold and the protruding portion can be made sufficiently small as compared to a case where the protruding portion is curved. This is because when the protruding portion has a linear shape, there is less variation in the shape of the protruding portion as compared to a case where the protruding portion is given a curved shape. Accordingly, an amount of resin that spreads through the gap can be suppressed.

### EFFECT OF THE INVENTION

The coil component according to the present invention enables a gap between a mold and an outer surface of a terminal during injection molding to be reduced. Accordingly, resin can be prevented from spreading to a mounting surface of the terminal.

### BRIEF DESCRIPTION OF THE DRAWINGS

The object described above as well as other objects, features, and advantages will be further clarified by the preferred embodiments described below and the following accompanying drawings.

FIG. 1 is a perspective view showing an example of a coil component according to a first embodiment of the present invention.

FIG. 2 is an exploded perspective view of the coil component according to the first embodiment.

FIG. 3 is a top view of the coil component according to the first embodiment. However, an upper core, a terminal, and an opening of a terminal recessed portion are represented by dotted lines.

FIG. 4 is a bottom view of the coil component according to the first embodiment.

FIG. 5 is a longitudinal sectional view at center in a width direction of the coil component according to the first embodiment.

FIG. 6A is an enlarged view of a terminal and a vicinity thereof in FIG. 5. FIG. 6B is an enlarged view of a terminal and a vicinity thereof in FIG. 4.

FIG. 7 is a front view of the coil component according to the first embodiment. The terminal recessed portion and a contour of a recessed portion are depicted by dotted lines.

### DETAILED DESCRIPTION

Various constituent elements of a coil component according to the present invention need not be individually independent entities. A plurality of constituent elements may be formed as a single member, a single constituent element may be formed by a plurality of members, a given constituent element may constitute a part of another constituent element, a part of a given constituent element and a part of another constituent element may overlap with each other, and the like.

Hereinafter, an embodiment of the present invention will be described based on the drawings. In the respective drawings, corresponding constituent elements will be denoted by common reference signs and redundant descriptions will not be repeated.

In the present embodiment, descriptions will be given by defining directions of front, rear, left, right, up and down as illustrated. However, the directions are merely defined for the sake of convenience for explaining correspondence relationships among the constituent elements in a simple manner and are not intended to limit directions during production or during use of products that implement the present invention. A lower side refers to a substrate side when the coil component is mounted to a substrate (not illustrated) and an up-down direction coincides with a height direction of the coil component. In addition, a front-rear direction coincides with a winding axis direction of the coil component according to the first embodiment. A left-right direction coincides with a width direction of the coil component. Hereinafter, when simply referring to the winding axis direction and the width direction, the directions shall refer to the winding axis direction of the coil component and the width direction of the coil component, respectively. Furthermore, a direction from an outer edge toward a center of the coil component will be referred to as inside, inward or inward facing while a direction from the center toward the outer edge of the coil component will be referred to as outside, outward or outward facing.

Moreover, the term “flat surface” as used in the present invention means a shape having been physically formed with a flat surface as a goal and, obviously, the shape need not be geometrically perfectly flat.

### Coil Component

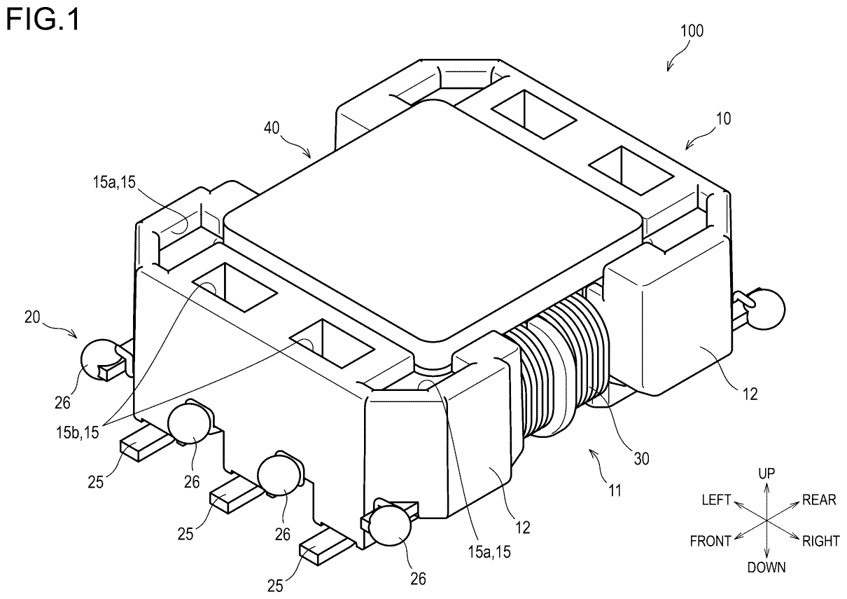

FIG. 1 is a perspective view showing an example of a coil component according to a first embodiment of the present invention.

First, an overview of a coil component 100 according to the present embodiment will be described.

The coil component 100 includes a base portion 10, a terminal 20 that protrudes from a lower surface of the base portion 10, and a coil 30 that is electrically connected to the terminal 20. The lower surface of the base portion 10 includes a lowermost portion that is positioned furthest downward and a protruding surface 13a that is positioned above the lowermost portion (in the present embodiment, a top wall that demarcates a terminal recessed portion 13 to be described later). The terminal 20 includes an embedded portion 21b, a protruding portion 21a, a bent portion (first bent portion 22), and a mounting portion 25. The embedded portion 21b is embedded in the base portion 10. The protruding portion 21a is continuous from the embedded portion 21b and protrudes downward from the protruding surface 13a, and has a linear shape. The first bent portion 22 is continuous from the protruding portion 21a and is bent toward a side of the base portion 10. The mounting portion 25 includes a mounting surface 25a that faces downward and the mounting portion 25 is continuous from the first bent portion 22.

When the protruding portion 21a has a linear shape, a mold can be sufficiently aligned with the protruding portion 21a during injection molding and the gap between the mold and the protruding portion 21a can be made small as compared to a case where the protruding portion 21a is curved. This is because when the protruding portion 21a has a linear shape, there is less variation in the shape of the protruding portion 21a as compared to a case where the protruding portion 21a is given a curved shape. Accordingly, an amount of resin that spreads through the gap can be reduced. Particularly, resin can be prevented from reaching the mounting surface 25a of the mounting portion 25 through the surface of the terminal 20 (such as an inward surface 21a1 to be described later) from the gap.

In addition, the protruding portion 21a protrudes downward from the protruding surface 13a that is arranged above the lowermost portion of the base portion 10. In this case, a distance along the surface of the terminal 20 between an upper end of the protruding portion 21a and the mounting surface 25a is sufficiently long as compared to a case where the protruding portion 21a protrudes from a height comparable to the lowermost portion. Accordingly, resin that leaks and spreads during injection molding can be prevented from reaching the mounting surface 25a.

Next, the coil component 100 according to the present embodiment will be described in detail. FIG. 1 is a perspective view of the coil component 100 according to the present embodiment.

The coil component 100 refers to an apparatus that includes the coil 30 and that is a component constituting a part of a circuit. In the present embodiment, the coil component 100 is a transformer. Other examples of the coil component include an antenna and an inductor.

The base portion 10 refers to a pedestal portion in which the terminal to be described later is embedded to be held. The base portion 10 is formed of an insulating material such as resin. More specifically, the base portion 10 is formed by injection molding of an insulating material as will be described later. The following description assumes that the base portion 10 has been molded using resin as the insulating material.

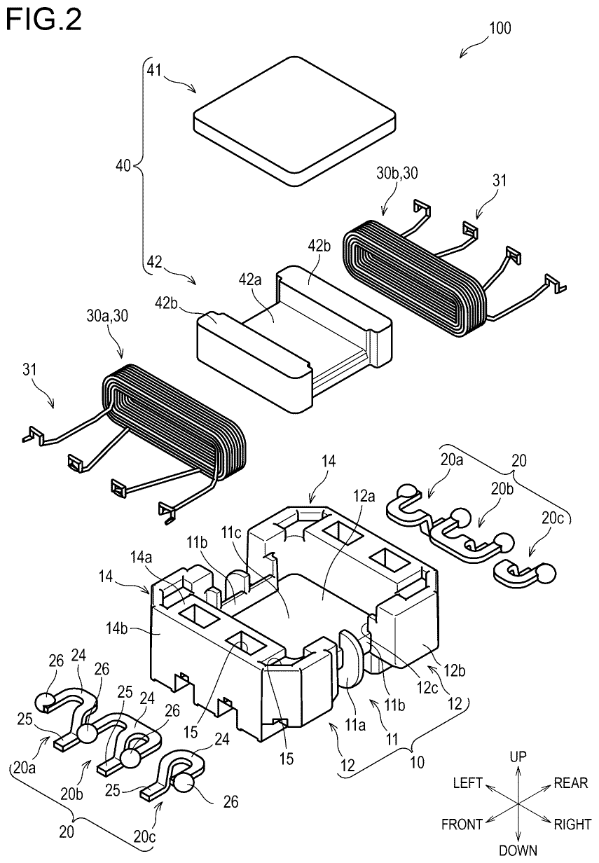

As illustrated in FIG. 2, the base portion 10 according to the present embodiment includes a bobbin portion 11 and a pair of flange accommodating portions 12.

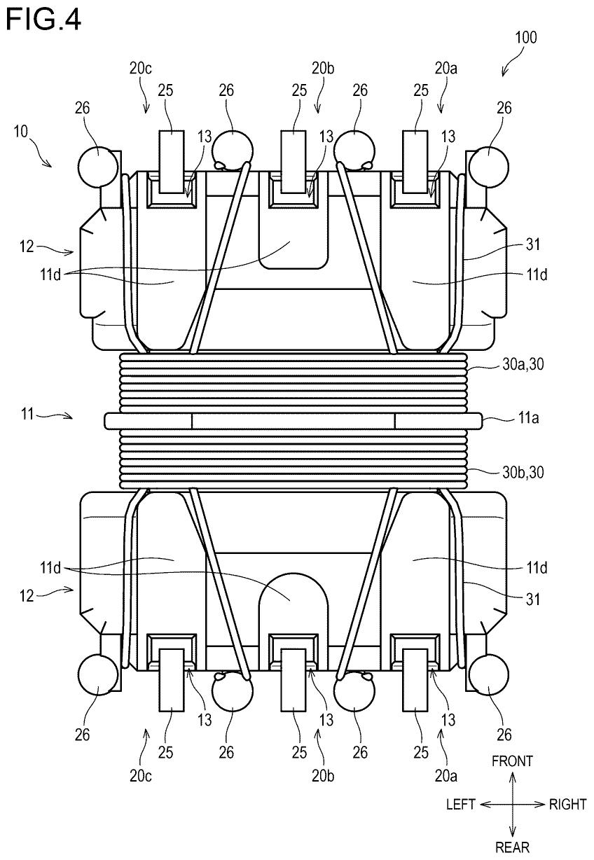

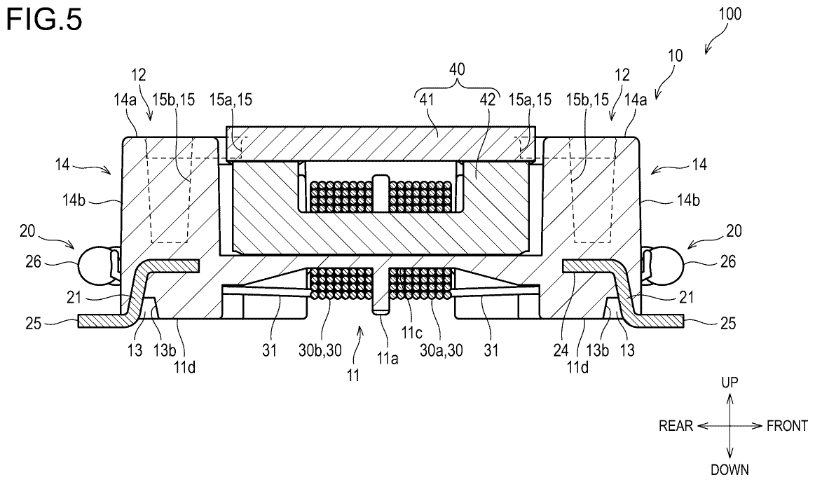

The bobbin portion 11 is a portion to be a winding shaft of the coil 30 to be described later. In the present embodiment, the bobbin portion 11 includes a space that is demarcated by a pair of side panels 11b, 11b provided separated from each other in a width direction of the coil component 100 and a bottom panel 11c and that is opened upward. A winding core portion 42a of a lower core 42 to be described later is to be accommodated in the space. As illustrated in FIGS. 4 and 5, a partition 11a is provided so as to approximately encircle the bobbin portion 11 with respect to the winding axis direction. Specifically, the partition 11a refers to a plate-like flange that is provided across each of the pair of side panels 11b and the bottom panel 11c and projects outward from the bobbin portion 11. Winding positions of a primary coil 30a and a secondary coil 30b to be described later are divided by the partition 11a.

As illustrated in FIG. 2, the pair of flange accommodating portions 12 is integrally formed with the bobbin portion 11 at both ends of the bobbin portion 11 in the winding axis direction. Each of the flange accommodating portions 12 is provided with a space that is demarcated by a bottom panel 12a, a wall portion 14, a flange-side portion 12b, and an inner wall 12c. A flange portion 42b of the lower core 42 to be described later is to be accommodated in the space. The space is opened upward and is also adjacent to and communicates with the space provided in the bobbin portion 11 in which the winding core portion 42a is to be accommodated. In other words, the shape of the base portion 10 is a concave shape that opens upward as a whole and the base portion 10 has a space to accommodate a core 40 (particularly, the lower core 42).

Note that the wall portion 14, the bottom panel 12a, and the flange-side portion 12b are integrally formed. The flange-side portions 12b are spaced apart in the width direction across the core 40. The flange-side portions 12b are integrally formed with the inner walls 12c and the side panels 11b.

As illustrated in FIG. 5 to be described later, a part of the terminal 20 is embedded in a bottom portion of the flange accommodating portion 12. In the present embodiment, the terminal 20 is embedded in a lower part of the wall portion 14.

The lowermost portion of the base portion 10 refers to a surface or a point that is arranged furthest downward in the base portion 10. Preferably, the lowermost portion of the base portion 10 refers to a surface or a point that is arranged furthest downward in a vicinity of where the terminal 20 is embedded in the base portion 10. The vicinity of where the terminal 20 is embedded refers to the flange accommodating portion 12 where the terminal 20 is embedded and preferably refers to a peripheral wall 13b that forms the terminal recessed portion to be described later. As illustrated in FIG. 5, the lowermost portion of the base portion 10 according to the present embodiment is a lower surface of the flange accommodating portion 12 (a downward-protruding area 11d to be described later) and is an open end (lower end) of the terminal recessed portion 13 to be described later.

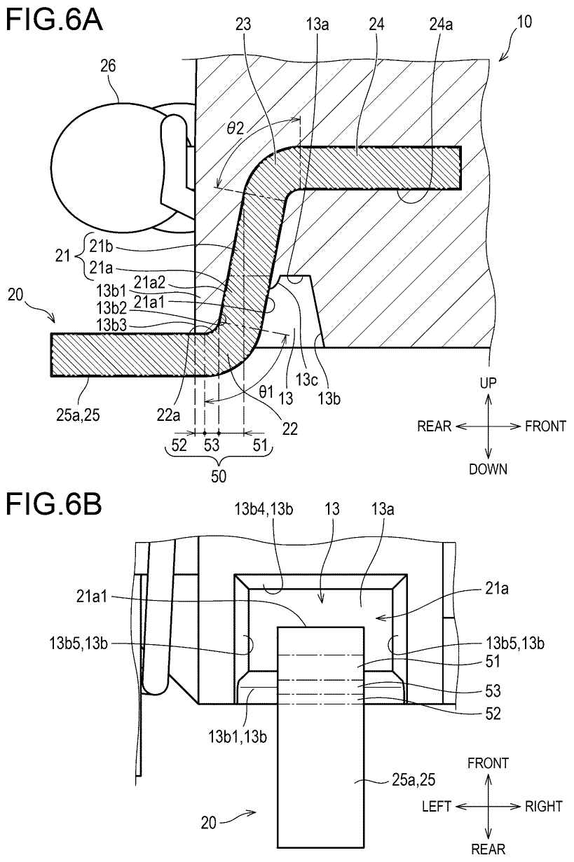

The protruding surface 13a refers to a surface from which the terminal 20 protrudes. It is a top wall (bottom portion arranged above) of the terminal recessed portion 13 to be described later in the present embodiment. As shown in FIG. 6B, the protruding surface 13a is arranged around a base end of the terminal (the protruding portion 21a to be described later). In other words, the protruding surface 13a is arranged to the side of the base end of the protruding portion 21a. Preferably, the protruding surface 13a is arranged so as to surround the base end of the protruding portion 21a. In other words, the base end of the protruding portion 21a and parts (an opposing portion 13b4 and a side portion 13b5 to be described later) of the peripheral wall 13b to be described later are separated from each other. In the present embodiment, the protruding surface 13a surrounds the base end of the terminal 20 in three directions (both outer sides in the width direction and an inner side in the winding axis direction). Instead of the present embodiment, the protruding surface 13a may be arranged outside the base end of the protruding portion 21a in one direction (either in the width direction or in the winding axis direction) or the protruding surface 13a may surround the entire circumference of the base end of the protruding portion 21a.

As illustrated in FIG. 2, the coil 30 according to the present embodiment is formed by winding coil wire. The coil 30 is constituted of coil wire wound directly or indirectly around the winding core portion 42a of the lower core 42 and the bobbin portion 11 or, in other words, a part of the core 40 and the bobbin portion 11 are arranged inside the coil 30. The coil 30 may be an air core coil without the core 40 or the bobbin portion 11 inside.

The coil component 100 according to the present embodiment is a transformer and the coil component 100 includes the primary coil 30a and the secondary coil 30b as the coil 30. The primary coil 30a and the secondary coil 30b according to the present embodiment are formed by two coil wires, respectively. In the present embodiment, the primary coil 30a is a coil on an input side and the secondary coil 30b is a coil on an output side. The primary coil 30a is wound on a forward side of the partition 11a in the bobbin portion 11 and the secondary coil 30b is wound on a rearward side of 11a in the bobbin portion 11. Two or more coil wires may be wound as the primary coil 30a or the secondary coil 30b as in the present embodiment or only one coil wire may be wound instead of the present embodiment.

As illustrated in FIG. 4, a coil wire (extracted portion 31) is extracted from the coil 30 to a forward side or a rearward side. The extracted portion 31 follows a shape of the lower surface of the base portion 10 and is connected to a wire-joining portion 26 to be described later. Specifically, the extracted portion 31 that is connected to the wire-joining portion 26 of a second terminal 20b to be described later passes through a recessed groove formed on a lower surface of the flange accommodating portion 12 along the winding axis direction. The downward-protruding area 11d is formed in plurality on the lower surface of the base portion 10. The downward-protruding area 11d refers to a part of the base portion 10 provided so as to protrude more downward than the top wall of the recessed groove. The recessed groove is demarcated by two downward-protruding areas 11d by being sandwiched between the two downward-protruding areas 11d. The extracted portion 31 to be connected to a first terminal 20a or a third terminal 20c is routed along a side surface of the downward-protruding areas 11d.

As illustrated in FIG. 2, each of the pair of wall portions 14 arranged separated from each other in the winding axis direction includes three terminals 20 (the first terminal 20a, the second terminal 20b, and the third terminal 20c). The first terminal 20a and the third terminal 20c differ from the second terminal 20b in that the first terminal 20a and the third terminal 20c include one wire-joining portion 26 to be described later while the second terminal 20b includes two wire-joining portions 26. As illustrated in FIG. 6A, the terminal 20 includes the wire-joining portion 26, a base end portion 24, an intermediate portion 21, and the mounting portion 25.

The wire-joining portion 26 refers to a part to which an end portion of the coil wire (extracted portion 31) having been extracted from the coil 30 is connected. The coil component 100 according to the present embodiment is manufactured by connecting an end portion of the extracted portion 31 to the wire-joining portion 26 during a manufacturing process and welding the wire-joining portion 26 and the end portion of the extracted portion 31 to each other. The wire-joining portion 26 and the extracted portion 31 may be joined by soldering or the like.

The mounting portion 25 is a part of the terminal 20 that is grounded to the substrate (not illustrated) when mounting the coil component 100. Specifically, the mounting portion 25 includes the mounting surface 25a that faces downward and the mounting surface 25a and the substrate come into surface contact with each other. The mounting portion 25 and the substrate are joined to each other by soldering or the like.

In the present embodiment, a part on an upper side of the intermediate portion 21 (embedded portion 21b) is embedded in the base portion 10 and a part on a lower side (protruding portion 21a) is exposed from the base portion 10. Specifically, the protruding portion 21a protrudes downward from the protruding surface 13a to be described later in the base portion 10. In this case, downward means an orientation with an up-down direction component and includes an orientation that is parallel to the up-down direction but is not limited to a direction that is parallel to the up-down direction. In the present embodiment, the protruding portion 21a protrudes from the base portion 10 at an oblique angle to the up-down direction as will be described later.

The embedded portion 21b refers to a part on a side of the mounting portion 25 that is embedded in the base portion 10 in an end portion extending from the base end portion 24 to the mounting portion 25 (including a second bent portion 23, the intermediate portion 21, the first bent portion 22, and the mounting portion 25 to be described below). While the embedded portion 21b is a part on the upper side in the intermediate portion 21 as described above in the present embodiment, the embedded portion 21b may be the second bent portion 23 instead of the present embodiment. In this case, the entire intermediate portion 21 is to constitute the protruding portion 21a.

The protruding portion 21a having a linear shape means that the entire protruding portion 21a has an approximately linear shape and is not limited to having a completely linear shape. Specifically, the shape of the protruding portion 21a may be an approximately linear shape that is slightly more gently curved than a curved shape of the first bent portion 22. More specifically, the protruding portion 21a may be slightly curved toward the side to the extent that an inward surface 21a1 to be described later in the protruding portion 21a is approximately flat.

The protruding portion 21a includes the inward surface 21a1 and an outward surface 21a2 that oppose each other. The inward surface 21a1 of the protruding portion 21a refers to a surface facing inward in the winding axis direction and the outward surface 21a2 refers to a surface facing outward in the winding axis direction. In the present embodiment, the inward surface 21a1 and the outward surface 21a2 of the protruding portion 21a are main surfaces in the protruding portion 21a. In the present embodiment in which the terminal recessed portion 13 is formed, the inward surface 21a1 of the protruding portion 21a faces the inside of the terminal recessed portion 13. In addition, in a case where the protruding portion 21a is arranged at an oblique angle to the up-down direction as in the present embodiment, the outward surface 21a2 faces upward and the inward surface 21a1 faces downward.

The terminal 20 is bent at the first bent portion 22 between the mounting portion 25 and the intermediate portion 21 and is bent at the second bent portion 23 between the intermediate portion 21 and the base end portion 24. The first bent portion 22 is bent from the intermediate portion 21 so that the mounting portion 25 is oriented toward the side of the base portion 10. In other words, the bending direction of the first bent portion 22 refers to a direction from a lower end of the intermediate portion 21 (a base end of the first bent portion 22) toward the side of the base portion 10. In this case, the side refers to a direction including a component in the width direction or the winding axis direction and includes a direction orthogonal to the up-down direction but is not limited to a direction orthogonal to the up-down direction. The bending direction of the first bent portion 22 in the present embodiment refers to outward in the winding axis direction. In addition, the second bent portion 23 is bent so that the intermediate portion 21 is bent in a downward direction from the base end portion 24. The bending direction of the second bent portion 23 is downward. In this case, downward refers to an orientation with an up-down direction component but is not limited to an orientation that is parallel to the up-down direction.

In addition, as illustrated in FIG. 2, one end portion including the wire-joining portion 26 and another end portion including the mounting portion 25 branch off from the base end portion 24 and extend in the front-rear direction. The second terminal 20b which includes two wire-joining portions 26 and one mounting portion 25 is split into three branches at the base end portion 24, with the wire-joining portions 26 arranged on both outer sides in the width direction and the mounting portion 25 at the center. The first terminal 20a and the third terminal 20c, each including one wire-joining portion 26 and one mounting portion 25, have the wire-joining portion 26 arranged on an outer side in the width direction and the mounting portion 25 arranged on an inner side in the width direction.

By using the terminal 20 in which the total number of mounting portions 25 is smaller than the total number of wire-joining portions 26 like the second terminal 20b, points where the coil component 100 is grounded to the substrate during mounting can be reduced as compared to a case where the total number of wire-joining portions 26 and the total number of mounting portions 25 are the same. Accordingly, grounding between the coil component 100 and the substrate can be further stabilized.

While each wall portion 14 is provided with three terminals 20 in the present embodiment, the number of terminals 20 is not limited thereto. Each wall portion 14 may include one or two or more terminals 20.

While the terminals 20 according to the present embodiment have a shape of a folded flat plate and a rectangular cross section, the terminals 20 are not limited thereto. For example, the terminals may have a shape of a folded wire or a folded rod-shaped member and, in this case, a part of the wire or the rod-shaped member may be squashed to form a flat surface and the flat surface may be adopted as the mounting surface 25a (refer to FIG. 6A).

The core 40 is formed of a magnetic material such as ferrite. As illustrated in FIG. 2, in the present embodiment, the core 40 is constituted of two core members (an upper core 41 and a lower core 42). The core 40 may be constituted of one core member or constituted of two or more core members. In addition, while the upper core 41 is a plate-like I-shaped core and the lower core 42 is a U-shape core which combine to form a closed magnetic path in the present embodiment, the cores are not limited thereto. Two U-shaped cores may be combined or the upper core 41 that is a U-shaped core and the lower core 42 that is an I-shaped core may be combined.

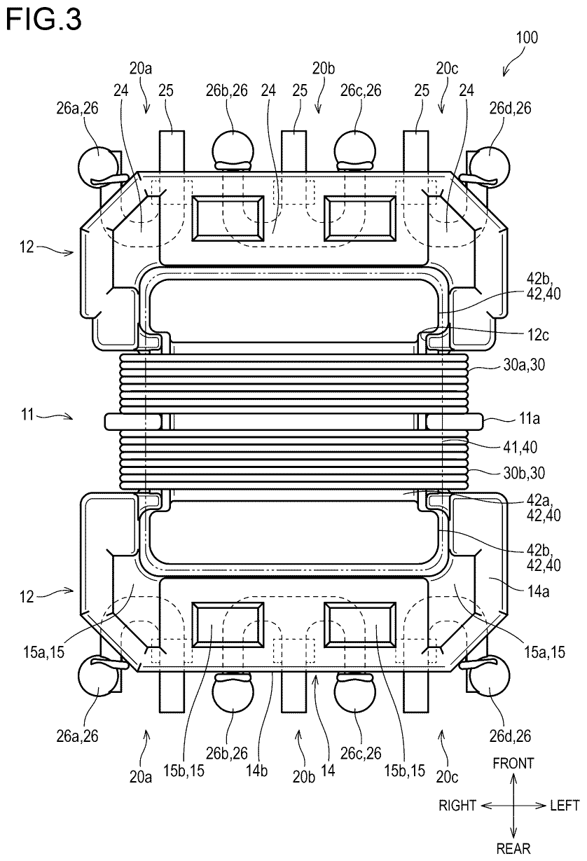

The lower core 42 includes a winding core portion 42a around which the coil 30 is wound and a pair of flange portions 42b formed at both ends of the winding core portion 42a in the winding axis direction. The flange portions 42b protrude more upward than an upper surface of the winding core portion 42a. As illustrated in FIG. 3, the flange portions 42b protrude toward both sides in the width direction than the winding core portion 42a. In addition, both inner corners in the winding axis direction (a pair of corners extending in the up-down direction and separated from each other in the width direction) of each of the flange portions 42b in a top view are depressed so as to correspond to an outer shape of the inner wall 12c. In addition, an upper surface of the flange portions 42b is arranged above an upper end of the inner wall 12c. On the other hand, a shape of the winding core portion 42a in the lower core 42 is a plate shape. As illustrated in FIG. 2, the corner arranged upward among the corners along the winding axis direction in the winding core portion 42a is chamfered.

The upper core 41 has a thin plate shape in the height direction. As illustrated in FIG. 3, the upper core 41 has a larger dimension than the lower core 42 in the winding axis direction and the width direction. The dimension of the upper core 41 and the maximum dimension of the lower core 42 may be comparable in the winding axis direction and the width direction. Both ends of the upper core 41 are arranged between the pair of flange-side portions 12b (refer to FIG. 2). As illustrated in FIG. 5, the upper surface of the upper core 41 is arranged above the upper surface of the base portion 10 and an upper part of the upper core 41 is arranged outside the base portion 10.

While the lower surface of the upper core 41 and the upper surface of the lower core 42 (flange portion 42b), and the lower surface of the lower core 42 and the bottom panel 11c of the base portion 10, are glued together by an adhesive in the present embodiment, the surfaces and the plate need not be glued to each other and only parts thereof may be in contact with each other.

As illustrated in FIG. 6A, the base portion 10 includes a side wall 13b1 that is arranged outside of the protruding portion 21a in a bending direction of the first bent portion 22 (outward in the winding axis direction). The protruding portion 21a and the side wall 13b1 overlap with each other in an overlap area (first overlap area 51) in a bottom view. The protruding portion 21a and the side wall 13b1 are in contact with each other in the first overlap area 51. Since adopting this configuration prevents formation of a recessed portion that is provided around the terminal 20 such that an interior cannot be visually recognized from the up-down direction, the base portion 10 can be injection-molded without using a slide mold to be used by being inserted from the side of the coil component 100.

The side wall 13b1 refers to a part in the lower part of the base portion 10 that overlaps with a part of or all of the protruding portion 21a as viewed in the winding axis direction and arranged on an outward side than the protruding portion 21a in the winding axis direction. In the present embodiment, this is a part that is arranged on an outer side in the winding axis direction in the peripheral wall 13b that demarcates the terminal recessed portion 13 to be described later. The side wall 13b1 includes an inward surface 13b2 that faces inside in the winding axis direction and an outward surface 13b3 that opposes the inward surface 13b2 and faces outside in the winding axis direction. The outward surface 13b3 of the side wall 13b1 is a part of the side surface of the base portion 10 (a wall portion outside surface 14b to be described later) and the outward surface 13b3 of the side wall 13b1 and the side surface of the base portion 10 are on a same plane. The outward surface 13b3 of the side wall 13b1 extends in the up-down direction or is arranged to be inclined obliquely to the up-down direction so that the outward surface 13b3 is continuously arranged outside in the winding axis direction from an upper end to a lower end. In addition, the outward surface 13b3 of the side wall 13b1 is flat and the outward surface 13b3 is not provided with a recessed portion that opens toward the side.

As described above, the intermediate portion 21 (protruding portion 21a) is inclined obliquely to the up-down direction and the lower end of the intermediate portion 21 is arranged on an outer side in the winding axis direction than the upper end. Therefore, the protruding portion 21a and the side wall 13b1 that is arranged outside the protruding portion 21a in the winding axis direction overlap with each other in a bottom view.

In this case, the overlap between a part of the terminal 20 (the protruding portion 21a and the like) and the side wall 13b1 in a bottom view is not limited to being directly visually confirmable. For example, a part of the terminal 20 and the side wall 13b1 need only be arranged so as to overlap with each other in the up-down direction when viewed in a vertical cross section as in FIG. 6A. Similarly, when referring to a top view or a bottom view hereinafter, a predetermined aspect is not limited to being directly visually confirmable and the aspect need only be confirmable in a sectional view such as a vertical cross section.

The protruding portion 21a and the side wall 13b1 being in contact with each other in the first overlap area 51 more specifically means that the outward surface 21a2 of the protruding portion 21a and the inward surface 13b2 of the side wall 13b1 oppose, and are in contact with, each other. The protruding portion 21a and the side wall 13b1 are in contact with each other across approximately an entirety of the first overlap area 51. In other words, the protruding portion 21a and the side wall 13b1 overlap with each other from one end on the inner side to the other end on the outer side in the winding axis direction in the first overlap area 51. However, the protruding portion 21a and the side wall 13b1 may be separated from each other in a very small part due to a void created during injection molding or the like.

While an entirety of the outward surface 21a2 of the protruding portion 21a is covered by the side wall 13b1 and in contact with the side wall 13b1 in the present embodiment, the outward surface 21a2 is not limited thereto. Only a part on an upper side of the outward surface 21a2 of the protruding portion 21a may be covered by the side wall 13b1 and an upper part of the protruding portion 21a that overlaps with the side wall 13b1 in a bottom view may be in contact with the side wall 13b1. In this case, the mounting portion 25 and the first bent portion 22 (particularly, the upper surface to be described later) do not overlap with the side wall 13b1 in a bottom view and are arranged outward in the winding axis direction than the outward surface 13b3 of the side wall 13b1.

In addition, the wall portion outside surface 14b to be described later preferably extends parallel to the up-down direction or is formed to be inclined obliquely outward toward below so that an upper end portion of the wall portion outside surface 14b is arranged on an inner side in the winding axis direction than a lower end portion. Furthermore, preferably, the wall portion outside surface 14b is not provided with a recessed portion or, even when a recessed portion is provided, an entirety of an interior of the recessed portion is visually recognizable in a top view. In other words, the wall portion outside surface 14b is constituted by a part or a whole that extends parallel to the up-down direction or by a part or a whole that is visually recognizable in a top view. In this case, the wall portion outside surface 14b being visually recognizable in a top view means that a situation where a part of the wall portion outside surface 14b is covered by another part of the wall portion outside surface 14b and cannot be visually recognized never occurs when other members such as the wire-joining portion 26 are absent.

As illustrated in FIG. 6A, the mounting portion 25 and the side wall 13b1 overlap with each other in a second overlap area (a second overlap area 52) in a bottom view. The mounting portion 25 and the side wall 13b1 are in contact with each other in the second overlap area 52. Adopting such a configuration enables the base portion 10 to be injection-molded without a slide mold.

In the present embodiment, a lower end portion of the side wall 13b1 has a predetermined thickness in the winding axis direction and has a flat lower surface. The mounting portion 25 and the side wall 13b1 overlapping with each other in the second overlap area 52 means that the upper surface that faces upward in the mounting portion 25 and the lower surface described above in the side wall 13b1 oppose, and are in contact with, each other. The mounting portion 25 and the side wall 13b1 are in contact with each other across an entirety of the second overlap area 52. In other words, the mounting portion 25 and the side wall 13b1 overlap with each other from one end on the inner side to the other end on the outer side in the winding axis direction in the second overlap area 52. However, the mounting portion 25 and the side wall 13b1 may be separated from each other in a very small part due to a void created during injection molding or the like.

While the protruding portion 21a is arranged to be inclined obliquely to the up-down direction as described above in the present embodiment, the protruding portion 21a is not limited thereto. The protruding portion 21a may be arranged parallel to the up-down direction. In this case, the side wall 13b1 and the protruding portion 21a do not overlap with each other in a bottom view while the side wall 13b1 and the mounting portion 25 overlap with each other in the second overlap area 52.

In addition, the first bent portion 22 and the side wall 13b1 overlap with each other in a third overlap area 53 in a bottom view and the first bent portion 22 and the side wall 13b1 are in contact with each other across an entirety of the third overlap area 53. In other words, the first bent portion 22 and the side wall 13b1 overlap with each other from one end on the inner side to the other end on the outer side in the winding axis direction in the third overlap area 53. In this case, the first bent portion 22 and the side wall 13b1 being in contact with each other means that an upper surface 22a that faces a side of a center of bending in the first bent portion 22 and a part of a surface of the side wall 13b1 (a boundary portion between the outward surface 13b3 and the lower surface) oppose, and are in contact with, each other. The first overlap area 51 and the third overlap area 53, as well as the third overlap area 53 and the second overlap area 52, are adjacent to each other and form a continuous overlap area.

Hereinafter, the first overlap area 51, the second overlap area 52, and the third overlap area 53 may be collectively referred to as an overlap area 50.

However, when a bend radius in the first bent portion 22 is zero, the top surface of the first bent portion 22 may be substantially a line. In this case, the second overlap area 52 and the first overlap area 51 are substantially adjacent and continuous.

In the present embodiment, the lower surface of the base portion 10 is provided with the terminal recessed portion 13 that is surrounded by the peripheral wall 13b and the protruding surface 13a. The protruding portion 21a protrudes from the protruding surface 13a that is a top wall of the terminal recessed portion 13 and is surrounded by the peripheral wall 13b. A part of the peripheral wall 13b is the side wall 13b1 and is in contact with the protruding portion 21a. As illustrated in FIG. 6B, another part of the peripheral wall 13b is arranged in a vicinity of the protruding portion 21a but separated from the protruding portion 21a. Adopting such a configuration increases a shortest distance between a base end of the protruding portion 21a and a base end side of the mounting portion 25 along the inward surface 21a1 and the lower surface (surface facing downward) of the first bent portion 22 and a shortest distance between a base end of the protruding portion 21a and a base end side of the mounting portion 25 along a side end surface (surface facing outward in the width direction) of the protruding portion 21a and a side end surface of the first bent portion 22. Therefore, resin can be prevented from traveling along the inward surface 21a1 or the side end surface of the terminal recessed portion 13 and reaching the mounting surface 25a during injection molding.

The terminal recessed portion 13 refers to a bottomed recessed portion in which the terminal 20 (protruding portion 21a) is arranged and which is provided on the lower surface of the base portion 10 so as to open downward. As illustrated in FIG. 6B, while a shape of an opening of the peripheral wall 13b is a rectangular shape in a bottom view in the present embodiment, the shape may be a circular shape or a polygonal shape.

The peripheral wall 13b surrounds the protruding portion 21a on all four sides (both sides in the winding axis direction and both sides in the width direction) in a gapless manner. The side wall 13b1 and the protruding portion 21a being in contact with each other means that, as described above and illustrated in FIG. 6A, the inward surface 13b2 of the side wall 13b1 and the outward surface 21a2 of the protruding portion 21a are in contact with each other. The peripheral wall 13b being arranged in a vicinity of the protruding portion 21a means that, as illustrated in FIG. 5, the terminal recessed portion 13 is provided in the wall portion 14 and the peripheral wall 13b constitutes a part of the lower part of the wall portion 14. Preferably, a distance between the peripheral wall 13b and the protruding portion 21a is smaller than a distance between the terminal 20 (protruding portion 21a) that protrudes from the terminal recessed portion 13 and an adjacent terminal 20 (protruding portion 21a). More preferably, the distance between the peripheral wall 13b and the protruding portion 21a is equal to or smaller than twice the thickness (dimension in the winding axis direction) of the protruding portion 21a.

The protruding portion 21a being separated from another part of the peripheral wall 13b means that the protruding portion 21a is separated from the peripheral wall in three directions. Specifically, the protruding portion 21a is separated from a part of the peripheral wall 13b (opposing portion 13b4) that is arranged on an inner side than the protruding portion 21a in the winding axis direction and that opposes the inward surface 13b2 of the protruding portion 21a. In addition, the protruding portion 21a is also separated from a part of the peripheral wall (side portion 13b5) that is arranged on both outer sides of the protruding portion 21a in the width direction and that opposes the side end surface of the protruding portion 21a.

In the present embodiment, a distance between the protruding portion 21a (particularly, a base end portion of the inward surface 21a1 thereof) and the opposing portion 13b4 (particularly, a base end portion thereof) is greater than a distance between the protruding portion 21a (particularly, a base end portion of a side end surface thereof) and each of the pair of side portions 13b5 (particularly, a base end portion thereof). An amount of resin that leaks out along the inward surface 21a1 of the protruding portion 21a during injection molding is larger than an amount of resin that leaks out along the side end surface of the protruding portion 21a. This is because a width (dimension in the width direction) of the inward surface 21a1 of the protruding portion 21a is larger than the side end surface (dimension in the winding axis direction) of the protruding portion 21a. Setting the distance between the protruding portion 21a and the opposing portion 13b4 greater than the distance between the protruding portion 21a and the side portion 13b5 prevents the resin having leaked out along the inward surface 21a1 of the protruding portion 21a during injection molding from adhering to the opposing portion 13b4 and filling the terminal recessed portion 13. In addition, since the leaked resin is less likely to adhere to the opposing portion 13b4, a covering portion 13c to be described later can be provided at a desired thickness.

As illustrated in FIG. 6A, a height (distance in the up-down direction) of the protruding surface 13a based on the lowermost portion is larger than a dimension of the first bent portion 22 in the up-down direction. Arranging the protruding surface 13a sufficiently above enables a long distance to be secured between the protruding surface 13a and the mounting surface 25a and prevents resin that flows out during injection molding from reaching the mounting surface 25a.

In the present embodiment, the height of the protruding surface 13a based on the lowermost portion refers to a depth of the terminal recessed portion 13 and a height to the protruding surface 13a based on a lower end of the peripheral wall 13b. The dimension of the first bent portion 22 in the up-down direction refers to a height dimension to the upper end based on the lower end of the first bent portion 22.

The dimension of the protruding portion 21a in the up-down direction is larger than the dimension of the first bent portion 22 in the up-down direction. Securing a sufficient dimension of the protruding portion 21a increases an area where the inward surface 21a1 of the protruding portion 21a and a mold for injection molding come into contact with each other and enables leakage of resin during injection molding to be suppressed.

The dimension of the protruding portion 21a in the up-down direction refers to a height dimension to the upper end of the protruding portion 21a based on the lower end of the protruding portion 21a. The dimension of the protruding portion 21a in the up-down direction is preferably equal to the depth of the terminal recessed portion 13 or smaller than the depth of the terminal recessed portion 13. This is because arranging the entirety of the protruding portion 21a inside the terminal recessed portion 13 enables the protruding portion 21a to be sufficiently protected by the peripheral wall 13b. Alternatively, the dimension of the protruding portion 21a in the up-down direction may be larger than the depth of the terminal recessed portion 13 and a lower part of the protruding portion 21a may be arranged outside an envelope volume of the terminal recessed portion 13.

A bending angle θ1 of the first bent portion 22 is smaller than 90 degrees and the protruding portion 21a is arranged obliquely to the mounting portion 25. In other words, an angle formed by a part of the terminals 20 from the mounting portion 25 to the intermediate portion 21 around the first bent portion 22 is an obtuse angle (an angle greater than 90 degrees). Accordingly, the terminals 20 from the protruding portion 21a to the mounting portion 25 have enough elasticity to readily deform due to an external force with a component in the up-down direction. Specifically, the protruding portion 21a, the first bent portion 22, and the mounting portion 25 are deformable so as to increase or reduce the bending angle of the first bent portion 22. Therefore, the protruding portion 21a and the mounting portion 25 readily deform so as to conform to a shape of a mold for injection molding during injection molding and resin leakage during injection molding can be more favorably prevented. In addition, arranging the protruding portion 21a obliquely with respect to the up-down direction allows for a longer length to be secured along the surface from an upper end to a lower end of the inward surface 21a1 of the protruding portion 21a with respect to the height dimension of the protruding portion 21a. Accordingly, resin having leaked out during injection molding can be more favorably prevented from reaching the mounting surface 25a.

In this case, a bending angle refers to an angle by which a plate-like or linear-shaped conductive member is bent when subjecting the conductive member to bending work to form a bent portion (the first bent portion 22 or the second bent portion 23). In other words, the bending angle refers to a center angle of the bent portion and is an angle formed by a boundary surface between the bent portion in the terminal 20 after the bending work and a part of the terminal 20 adjacent to the bent portion on one side and a boundary surface between the bent portion and a part of the terminal 20 adjacent to the bent portion on the other side. For example, the bending angle θ1 is an angle formed by a boundary surface between the first bent portion 22 and the protruding portion 21a and a boundary surface between the first bent portion 22 and the mounting portion 25. The bending angle θ1 can be described to be a complementary angle of an angle that a part of the terminals 20 from the mounting portion 25 to the protruding portion 21a (intermediate portion 21) form around the first bent portion 22.

In addition, in the present embodiment, a bending angle θ2 of the second bent portion 23 is also smaller than 90 degrees and the intermediate portion 21 is also obliquely arranged with respect to the base end portion 24. Accordingly, a part from the intermediate portion 21 to the base end portion 24 also has enough elasticity to be deformable due to an external force with a component in the up-down direction. In other words, in the present embodiment, a part of the terminals from the base end portion 24 to the mounting portion 25 deforms into a flat shape as a whole by an external force with a component in the up-down direction and has a restoring force that tries to recover its original shape by its own elasticity.

As described above, the terminal 20 is formed so that a part including the mounting portion 25 and the protruding portion 21a, and the wire-joining portion 26 to which the end portion of the coil wire (the extracted portion 31) extracted from the coil connects, diverge at the base end portion 24 of the terminal 20. The terminal 20 is bent at the second bent portion (second bent portion 23) that is positioned between the base end portion 24 and the protruding portion 21a. The base end portion 24 includes a lower surface (base end portion lower surface 24a) that is continuous with the mounting surface 25a and faces downward. Adopting such a configuration enables a bent shape of the terminal 20 to be readily formed by sandwiching a plate-like conductive member with a predetermined mold from above and below.

In this case, the base end portion lower surface 24a and the mounting surface 25a being continuous means that the base end portion lower surface 24a is continuous in a smooth manner with the mounting surface 25a via a surface of the second bent portion 23, a surface of the intermediate portion 21 including the inward surface 21a1 in the protruding portion 21a, and a surface of the first bent portion 22. In other words, in the plate-like conductive member prior to the bending work, an area to become the base end portion lower surface 24a and an area to become the mounting surface 25a are a same flat surface. In addition, the base end portion lower surface 24a is continuous with the lower surface of the wire-joining portion 26. In the present embodiment, the base end portion lower surface 24a and the lower surface of the wire-joining portion 26 are arranged on a same flat surface.

Instead of the present embodiment, the upper surface of the base end portion 24 may be continuous with the mounting surface 25a and may also be continuous with the upper surface of the wire-joining portion 26. In other words, the terminal 20 may be created by subjecting a plate-like conductive member to bending work into a C-shape so that one main surface of the plate-like conductive member prior to the bending work faces a center of bending and another main surface of the plate-like conductive member prior to the bending work faces an outward side of the terminal 20.

The side wall 13b1 becomes thinner downward. Accordingly, when stress is applied to the terminal 20 due to an external force, damages the terminal 20 or causes the terminal 20 to deteriorate by a situation where the stress concentrates at the base end of the protruding portion 21a or the like can be prevented.

A thickness of the side wall 13b1 refers to a dimension in the winding axis direction. In the present embodiment, the thickness of the side wall 13b1 continuously changes in the up-down direction due to the outward surface 13b3 of the side wall 13b1 extending parallel to the up-down direction and the inward surface 13b2 of the side wall 13b1 obliquely extending with respect to the up-down direction as described above. A maximum thickness (a thickness at the upper end) of the side wall 13b1 in the present embodiment is smaller than a thickness of the terminal 20.

Instead of the present embodiment, the thickness of the side wall 13b1 may be the same in the up-down direction.

As described above, the protruding portion 21a includes the inward surface 21a1 that faces downward. An upper part of the inward surface 21a1 is covered by a covering portion 13c that is a part of the base portion 10 that extends out from the protruding surface 13a and comes into close contact with the upper part. A lower part of the inward surface 21a1 is exposed from the covering portion 13c of the base portion 10. An upper part of the protruding portion 21a is arranged between the side wall 13b1 and the covering portion 13c. A thickness of the covering portion 13c is smaller than the thickness of the side wall 13b1. When an external force is applied to the terminal 20 from the substrate or the like, stress may concentrate on the terminal 20 (particularly, the base end of the protruding portion 21a) and a part of the base portion 10 in a vicinity of the terminal 20. Covering a part on the base end side of the protruding portion 21a with the covering portion 13c alleviates stress that acts on the terminal 20 and prevents the base portion 10 from being damaged. In addition, making the thickness of the covering portion 13c smaller than the thickness of the side wall 13b1 enables stress that acts on the base end side of the protruding portion 21a to be moderately alleviated due to an external force while ensuring flexibility of the protruding portion 21a with respect to the base portion 10. Furthermore, covering a part on the base end side of the protruding portion 21a with the covering portion 13c prevents the part from being damaged due to corrosion or the like.

The covering portion 13c refers to a part of the base portion 10 that protrudes downward from the protruding surface 13a. The covering portion 13c opposes the side wall 13b1 across the protruding portion 21a. The covering portion 13c and the peripheral wall 13b (the opposing portion 13b4 and the side portion 13b5) are separated from each other in the winding axis direction. The covering portion 13c is in close contact with at least a part of or approximately all of a part that is covered by the covering portion 13c (hereinafter, a covered area) in the inward surface 21a1 of the protruding portion 21a. The part of the covered area and the covering portion 13c may be separated from each other or simply be in contact with each other instead of being in close contact. End surfaces on both sides of the protruding portion 21a may be covered by the covering portion 13c or exposed from the covering portion 13c. When the side end surfaces of the protruding portion 21a are covered by the covering portion 13c, the portions can be prevented from becoming damaged and stress that acts on the protruding portion when an external force is applied to the terminal 20 can be alleviated. When the side end surfaces of the protruding portion 21a are exposed from the covering portion 13c, since the covering portion 13c need not be provided, the peripheral wall 13b (particularly, the side portion 13b5) and the protruding portion 21a can be readily separated from each other during injection molding.

A length in the covering portion 13c from the protruding surface 13a to a leading end (lower end) of the covering portion 13c along the inward surface 21a1 of the protruding portion 21a is referred to as a covering length. The covering length of the covering portion 13c is preferably equal to or less than half of the dimension of the protruding portion 21a in the up-down direction and more preferably equal to or less than half of the thickness of the terminal 20. In addition, the covering length of the covering portion 13c is preferably equal to or more than a quarter of the thickness of the terminal 20.

From the perspective of stress alleviation when an external force is applied to the terminal 20, the covering portion 13c preferably becomes thinner from the side of the protruding surface 13a toward the leading end.

Instead of the present embodiment, the covering portion 13c need not be provided and a part on the base end side of the protruding portion 21a may be exposed from the base portion 10.

As described above, the terminal 20 includes the wire-joining portion 26 that is electrically connected to the mounting portion 25 and to which the end portion of the coil wire (the extracted portion 31) extracted from the coil 30 is fixed. The wire-joining portion 26 protrudes toward outside of the base portion 10 from an outside surface (wall portion outside surface 14b) of the base portion 10 (wall portion 14). The coil component 100 includes the core 40 that is held by the base portion 10.

As illustrated in FIG. 3, an outward side in a protruding direction of the wire-joining portion 26 (outward in the winding axis direction) of the core 40 is covered by the wall portion 14 of the base portion 10. In addition, the core 40 is exposed from the base portion 10 in a top view. An upper surface or an outside surface of the wall portion 14 includes a recessed portion 15 with a bottom wall. The recessed portion 15 opens between the core 40 and the wire-joining portion 26 as viewed from above or viewed in an orientation that opposes the outside surface. Providing the recessed portion 15 in this manner enables a creepage distance between the extracted portion 31 fixed to the wire-joining portion 26 and the core 40 exposed from the base portion 10 to be increased. The creepage distance refers to a shortest distance between conductive materials such as the core 40 and the coil wire and is a distance along surfaces of other members such as the base portion 10. In the present embodiment, a creepage distance between the coil wire fixed to the wire-joining portion 26 and the core 40 exposed from the base portion 10 refers to a distance between the coil wire and the core 40 along an outside surface of the wall portion 14, the upper surface of the wall portion 14, and an interior of the recessed portion 15.

In this case, an outward side of the core 40 in a protruding direction of the wire-joining portion 26 being covered by the wall portion 14 means that at least a part of the lower core 42 is covered by the wall portion 14. In the present embodiment, a part of a lower side of the upper core 41 and an outer side of the lower core 42 in the protruding direction are covered by the wall portion 14.

In this case, the wall portion outside surface 14b refers to a surface facing outside of the coil component 100 among the side surfaces of the wall portion 14. The wall portion outside surface 14b according to the present embodiment refers to a surface that faces outside in the winding axis direction among the side surfaces of the wall portion 14.

The protruding direction of the wire-joining portion 26 refers to a direction toward a side of the coil component 100. While the wire-joining portion 26 protrudes outward in the winding axis direction in the present embodiment, the wire-joining portion 26 may protrude outward in the width direction instead. As illustrated in FIG. 3, corners of a boundary between the flange-side portion 12b (refer to FIG. 2) and the wall portion 14 (refer to FIG. 2) are chamfered and the wall portion outside surface 14b (refer to FIG. 2) includes the chamfered surface (an inclined surface created by the chamfering). While the wire-joining portion 26 of the first terminal 20a and the third terminal 20c protrudes from the chamfered surface, the protruding direction is the same as the wire-joining portion 26 of the second terminal 20b and is outward in the winding axis direction.

The core 40 being exposed from the base portion 10 in a top view means that at least a part of the core 40 (particularly, the upper core 41) can be visually recognized in a top view.

When the recessed portion 15 is provided so as to open on the upper surface of the wall portion 14 (wall portion upper surface 14a), the recessed portion 15 opens between the core 40 and the wire-joining portion 26 when viewed from above. When the recessed portion 15 is provided so as to open on the wall portion outside surface 14b, the recessed portion 15 opens between the wire-joining portion 26 and the core 40 when viewed in a direction opposing the outside surface on which the recessed portion 15 is provided (a direction facing inside in the winding axis direction).

In the present embodiment, the wall portion 14 is provided on both outer sides of the core 40 in the winding axis direction. The recessed portion 15 is provided in each of the pair of wall portions 14 that are arranged to be spaced apart in the winding axis direction.

Instead of the present embodiment, the recessed portion 15 may be provided on the wall portion outside surface 14b. When the recessed portion 15 is provided on the wall portion outside surface 14b, the recessed portion 15 being opened between the core 40 and the wire-joining portion as viewed from an orientation opposing the wall portion outside surface 14b is not limited to a case where the core 40 is visually recognizable from the orientation. In other words, an upper part (particularly, an upper surface) of the core 40 may be arranged below the wall portion upper surface 14a and the core 40 need not be visually recognizable when viewed from the orientation. In this case, the recessed portion 15 need only be opened at a height between a height of the upper surface of the core 40 and a height at which the wire-joining portion 26 is arranged on the wall portion outside surface 14b.

The coil component 100 includes a plurality of wire-joining portions 26 that protrude in a same direction. In the present embodiment, the wall portion 14 has a plurality of recessed portions 15 corresponding to each of the plurality of wire-joining portions 26. The recessed portions 15 that respectively correspond to the different wire-joining portions 26 are separated from each other. Instead of the present embodiment, the wall portion 14 may be provided with one recessed portion 15 in order to secure a creepage distance between the plurality of wire-joining portions 26 that protrude in the same direction and the core 40. For example, the recessed portion 15 that is elongated in the width direction may be provided in the wall portion 14. Providing a plurality of recessed portions 15 in the wall portion 14 and separating the recessed portions 15 from each other enables stiffness of the wall portion 14 to be maintained as compared to a case where the wall portion 14 is provided with only one recessed portion 15.

In this case, each recessed portion 15 corresponding to each wire-joining portion 26 means that each recessed portion 15 is arranged between the wire-joining portion 26 to which the recessed portion 15 corresponds and the core 40 as viewed from above or from the side. One recessed portion 15 may correspond to one wire-joining portion 26 as in the present embodiment or two or more recessed portions 15 may correspond to one wire-joining portion 26.

While the plurality of recessed portions 15 are separated from each other in the width direction in the present embodiment, the recessed portions 15 may be separated from each other in the winding axis direction. For example, when the plurality of wire-joining portions 26 protrude outward in the width direction and the plurality of wire-joining portion 26 are lined up in the winding axis direction, the plurality of recessed portions 15 may be separated from each other in the winding axis direction.

All of the recessed portions 15 may be only provided on either the upper surface or the outside surface of the wall portion 14 or a part of the recessed portions 15 may be provided on the upper surface of the wall portion 14 and the remaining part of the recessed portions 15 may be provided on the outside surface of the wall portion 14.

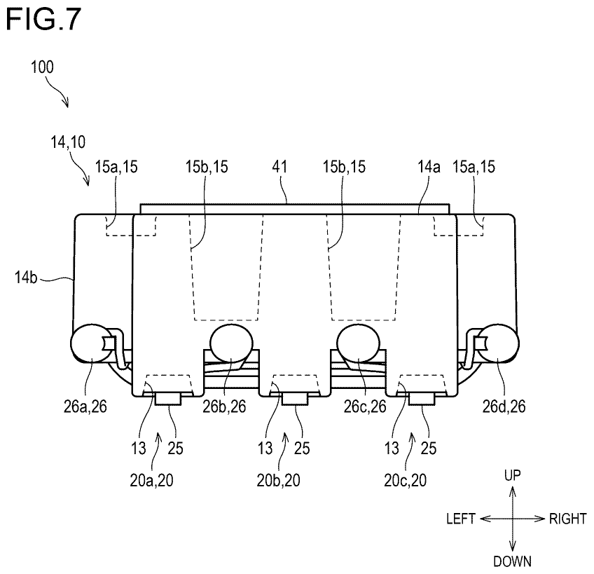

In the present embodiment, recessed portions 15a are provided so as to correspond to the wire-joining portions 26a and 26d of the first terminal 20a or the third terminal 20c, respectively, and recessed portions 15b are provided corresponding to the wire-joining portions 26b and 26c of the second terminal 20b, respectively. The plurality of recessed portions 15a and 15b are lined up in the width direction, the recessed portion 15a is arranged on both outer sides in the width direction, and the recessed portion 15b is arranged on an inner side in the width direction. A shape of the opening of the recessed portion 15a is an approximate pentagon and a shape of the opening of the recessed portion 15b is a rectangle. The shape of the opening of the recessed portion 15 may be a polygon or a circle. In addition, the recessed portion 15a communicates with a space that is provided in the flange accommodating portion 12 and in which the flange portion 42b of the lower core 42 is to be accommodated. As illustrated in FIG. 7, a depth (a dimension to an opening end with respect to bottom) of the recessed portion 15a is smaller than a depth of the recessed portion 15b. Reducing the depth of the recessed portion 15a that is arranged on an outer side in the width direction in the wall portion 14 enables stiffness of the wall portion 14 to be favorably maintained.

In the present embodiment, the recessed portion 15 is depressed downward from the upper surface of the wall portion 14. A dimension in the transverse direction of the recessed portion 15 either decreases or remains the same downward. Accordingly, the recessed portion 15 can be formed by injection molding without the need for a slide mold.

The dimension of the recessed portion 15 either decreases or remains the same downward in both the winding axis direction and the width direction.

In the present embodiment, as illustrated in FIGS. 5 and 7, each peripheral wall that demarcates the recessed portion 15 is obliquely arranged and inclined, and a dimension in the transverse direction of the recessed portion 15 decreases downward. As described above, the depth of one recessed portion 15 (recessed portion 15a) among the plurality of recessed portions 15a and 15b is smaller than the depth of the other recessed portion 15 (recessed portion 15b). An inclination angle of the peripheral wall of the one recessed portion 15a is larger than an inclination angle of the peripheral wall of the other recessed portion 15b. In this case, the inclination angle of a peripheral wall refers to an angle of the peripheral wall with respect to a horizontal plane. Accordingly, a large creepage distance can be secured even in the recessed portion 15a with a shallow depth as compared to a case where the inclination angle of the peripheral wall of the recessed portion 15a is equal to or smaller than the inclination angle of the peripheral wall of the recessed portion 15b.

A part of or all of the peripheral wall of the recessed portion 15 is inclined. At least a part of the peripheral wall opposing the protruding direction of the wire-joining portion 26 or an opposite direction to the protruding direction is inclined, and an inclination angle of the part of the peripheral wall in the recessed portion 15a is larger than an inclination angle of the part of the peripheral wall in the recessed portion 15b.

As illustrated in FIG. 3, the wire-joining portion 26 and the mounting portion 25 are positionally displaced in a top view. The top wall of the terminal recessed portion 13 and the bottom surface of the recessed portion 15 are positionally displaced in a same direction as the direction of the positional displacement of the wire-joining portion 26 and the mounting portion 25 in a top view. Accordingly, a situation where the terminal recessed portion 13 and the recessed portion 15 significantly overlap with each other in the up-down direction, thereby significantly reducing a thickness of a part of the wall portion 14 in the up-down direction and making the base portion 10 brittle can be prevented.

Specifically, the wire-joining portion 26 and the mounting portion 25 are positionally displaced in the width direction and the top wall of the terminal recessed portion 13 and the bottom surface of the recessed portion 15 are also positionally displaced in the width direction. In this case, the top wall of the terminal recessed portion 13 and the bottom surface of the recessed portion 15 being positionally displaced in a predetermined direction in a top view need only involve a center of the top wall of the terminal recessed portion 13 in a top view and a center of the bottom surface of the recessed portion 15 in a top view being positionally displaced in the predetermined direction. A part of the top wall of the terminal recessed portion 13 and a part of the bottom surface of the recessed portion 15 may overlap with each other in the up-down direction and the top wall of the terminal recessed portion 13 and the bottom surface of the recessed portion 15 may be separated from each other in a top view.

The terminal recessed portion 13 is arranged on an outer side in the protruding direction of the wire-joining portion 26 than a part of the recessed portion 15 in a top view. Accordingly, the base portion 10 can be prevented from becoming locally brittle as described above.

The terminal recessed portion 13 in a top view is arranged on an outer side in the protruding direction than a part of the recessed portion 15 on an inner side of the winding axis direction. Preferably, the terminal recessed portion 13 in a top view is arranged on an outer side in the protruding direction than a center of the bottom surface of the recessed portion 15 in a top view.

The present invention is not limited to the embodiment described above and includes aspects of various modifications, improvements, and the like insofar as the object of the present invention is achieved.

The modifications described below can be appropriately combined with one another.

While the space that is provided inside the base portion 10 and that accommodates the core 40 is opened upward in the present embodiment, the space is not limited thereto. For example, the space may be closed upward and opened in another direction. The space may be opened in one or both winding axis directions or in one or both width directions.

The winding axis direction of a coil may be the same direction as the up-down direction or the width direction.

While end portions of the coil wire are extracted to both sides in the winding axis direction and the coil component 100 is a so-called lateral coil in the present embodiment, the coil component 100 may be a so-called vertical coil in which an end portion of a coil wire is only extracted in one direction.

The embodiment described above covers the following technical ideas.

(1) A coil component, including:
a base portion; a terminal that protrudes from a lower surface of the base portion; and a coil that is electrically connected to the terminal, wherein
the lower surface of the base portion includes
   a lowermost portion that is positioned furthest downward and a protruding surface that is positioned above the lowermost portion, and
the terminal has
   an embedded portion that is embedded in the base portion,
   a protruding portion that is continuous from the embedded portion, protrudes downward from the protruding surface, and has a linear shape,
   a bent portion that is continuous from the protruding portion and is bent toward a side of the base portion, and
   a mounting portion that is continuous from the bent portion and includes a mounting surface facing downward.
      (2) The coil component according to (1), wherein
the base portion has
   a side wall that is arranged outside of the protruding portion in a bending direction of the bent portion,
the protruding portion and the side wall overlap with each other in an overlap area in a bottom view, and
the protruding portion and the side wall are in contact with each other in the overlap area.
   (3) The coil component according to (1) or (2), wherein
the base portion has
   a side wall that is arranged outside of the protruding portion in a bending direction of the bent portion,
the mounting portion and the side wall overlap with each other in a second overlap area in a bottom view, and
the mounting portion and the side wall are in contact with each other in the second overlap area.
   (4) The coil component according to (2) or (3), wherein
the lower surface of the base portion is provided with a terminal recessed portion that is surrounded by a peripheral wall and the protruding surface,
the protruding portion protrudes from the protruding surface being a top wall of the terminal recessed portion and is surrounded by the peripheral wall,
a part of the peripheral wall is the side wall and is in contact with the protruding portion, and
another part of the peripheral wall is arranged in a vicinity of the protruding portion and is separated from the protruding portion.
   (5) The coil component according to any one of (2) to (4), wherein a height of the protruding surface with respect to the lowermost portion is greater than a dimension of the bent portion in an up-down direction.
   (6) The coil component according to any one of (2) to (5), wherein a dimension of the protruding portion in the up-down direction is larger than a dimension of the bent portion in the up-down direction.
   (7) The coil component according to any one of (2) to (6), wherein
a bending angle of the bent portion is smaller than 90 degrees, and
the protruding portion is obliquely arranged with respect to the mounting portion.
   (8) The coil component according to (7), wherein
the side wall becomes thinner downward.
   (9) The coil component according to (8), wherein
the terminal is formed so that a part including the mounting portion and the protruding portion, and a wire-joining portion to which an end portion of a coil wire extracted from the coil connects, diverge at a base end portion of the terminal,
the terminal is bent at a second bent portion that is positioned between the base end portion and the protruding portion, and
the base end portion includes a lower surface that is continuous with the mounting surface and faces downward.
   (10) The coil component according to any one of (7) to (9), wherein
the protruding portion has an inward surface that faces downward,
an upper part of the inward surface is covered by a covering portion that is a part of the base portion that extends out from the protruding surface and comes into close contact with the upper part,
a lower part of the inward surface is exposed from the covering portion of the base portion,
an upper part of the protruding portion is arranged between the side wall and the covering portion, and
a thickness of the covering portion is smaller than a thickness of the side wall.
   (11) The coil component according to any one of (1) to (10), wherein
the terminal has a wire-joining portion which is electrically connected to the mounting portion and to which an end portion of a coil wire extracted from the coil is fixed,
the wire-joining portion protrudes toward outside of the base portion from an outside surface of the base portion,
the coil component has a core to be held by the base portion,
the core
   has an outward side in a protruding direction of the wire-joining portion being covered by a wall portion of the base portion and
   is exposed from the base portion in a top view,
an upper surface or the outside surface of the wall portion has a recessed portion with a bottom wall, and
the recessed portion opens between the core and the wire-joining portion as viewed from above or viewed in an orientation that opposes the outside surface.
   (12) The coil component according to (11), wherein
the coil component has a plurality of the wire-joining portions that protrude in a same direction,
the wall portion has a plurality of the recessed portions that correspond to the plurality of wire-joining portions, respectively, and
the recessed portions corresponding to the different wire-joining portions, respectively, are separated from each other.
   (13) The coil component according to (11) or (12), wherein
the recessed portion is depressed downward from the upper surface of the wall portion, and
a dimension in a transverse direction of the recessed portion either decreases or remains the same downward.
   (14) The coil component according to (13) which depends on (12), wherein
a dimension in the transverse direction of the plurality of recessed portions decreases downward,
each of the peripheral walls demarcating the plurality of recessed portions is inclined,
a depth of one of the recessed portions among the plurality of recessed portions is smaller than a depth of another of the recessed portions, and
an inclination angle of the peripheral wall of the one recessed portion is larger than an inclination angle of the peripheral wall of the other recessed portion.
   (15) The coil component according to any one of (11) to (14) which depends on (4), wherein
the wire-joining portion and the mounting portion are positionally displaced in a top view, and
the protruding surface of the terminal recessed portion and a bottom surface of the recessed portion are positionally displaced in a same direction as the direction of the positional displacement of the wire-joining portion and the mounting portion in a top view.
   (16) The coil component according to (15), wherein
the terminal recessed portion is arranged on an outer side in the protruding direction than a part of the recessed portion in a top view.

1. A coil component, comprising:
a base portion; a terminal that protrudes from a lower surface of the base portion; and a coil that is electrically connected to the terminal, wherein
the lower surface of the base portion includes
a lowermost portion that is positioned furthest downward and a protruding surface that is positioned above the lowermost portion, and
the terminal has
an embedded portion that is embedded in the base portion,
a protruding portion that is continuous from the embedded portion, protrudes downward from the protruding surface, and has a linear shape,
a bent portion that is continuous from the protruding portion and is bent toward a side of the base portion, and
a mounting portion that is continuous from the bent portion and includes a mounting surface facing downward.

2. The coil component according to claim 1, wherein
the base portion has
a side wall that is arranged outside of the protruding portion in a bending direction of the bent portion,
the protruding portion and the side wall overlap with each other in an overlap area in a bottom view, and
the protruding portion and the side wall are in contact with each other in the overlap area.

3. The coil component according to claim 1, wherein
the base portion has
a side wall that is arranged outside of the protruding portion in a bending direction of the bent portion,
the mounting portion and the side wall overlap with each other in a second overlap area in a bottom view, and
the mounting portion and the side wall are in contact with each other in the second overlap area.

4. The coil component according to claim 2, wherein
the lower surface of the base portion is provided with a terminal recessed portion that is surrounded by a peripheral wall and the protruding surface,
the protruding portion protrudes from the protruding surface being a top wall of the terminal recessed portion and is surrounded by the peripheral wall,
a part of the peripheral wall is the side wall and is in contact with the protruding portion, and
another part of the peripheral wall is arranged in a vicinity of the protruding portion and is separated from the protruding portion.

5. The coil component according to claim 2, wherein a height of the protruding surface with respect to the lowermost portion is greater than a dimension of the bent portion in an up-down direction.

6. The coil component according to claim 2, wherein a dimension of the protruding portion in the up-down direction is larger than a dimension of the bent portion in the up-down direction.

7. The coil component according to claim 2, wherein
a bending angle of the bent portion is smaller than 90 degrees, and
the protruding portion is obliquely arranged with respect to the mounting portion.

8. The coil component according to claim 7, wherein the side wall becomes thinner downward.

9. The coil component according to claim 8, wherein
the terminal is formed so that a part including the mounting portion and the protruding portion, and a wire-joining portion to which an end portion of a coil wire extracted from the coil connects, diverge at a base end portion of the terminal,
the terminal is bent at a second bent portion that is positioned between the base end portion and the protruding portion, and
the base end portion includes a lower surface that is continuous with the mounting surface and faces downward.

10. The coil component according to claim 7, wherein
the protruding portion has an inward surface that faces downward,
an upper part of the inward surface is covered by a covering portion that is a part of the base portion that extends out from the protruding surface and comes into close contact with the upper part,
a lower part of the inward surface is exposed from the covering portion of the base portion,
an upper part of the protruding portion is arranged between the side wall and the covering portion, and
a thickness of the covering portion is smaller than a thickness of the side wall.

11. The coil component according to claim 1, wherein
the terminal has a wire-joining portion which is electrically connected to the mounting portion and to which an end portion of a coil wire extracted from the coil is fixed,
the wire-joining portion protrudes toward outside of the base portion from an outside surface of the base portion,
the coil component has a core to be held by the base portion,
the core
has an outward side in a protruding direction of the wire-joining portion being covered by a wall portion of the base portion and
is exposed from the base portion in a top view,
an upper surface or the outside surface of the wall portion has a recessed portion with a bottom wall, and
the recessed portion opens between the core and the wire-joining portion as viewed from above or viewed in an orientation that opposes the outside surface.

12. The coil component according to claim 11, wherein
the coil component has a plurality of the wire-joining portions that protrude in a same direction,
the wall portion has a plurality of the recessed portions that correspond to the plurality of wire-joining portions, respectively, and
the recessed portions corresponding to the different wire-joining portions, respectively, are separated from each other.

13. The coil component according to claim 12, wherein
the recessed portion is depressed downward from the upper surface of the wall portion, and
a dimension in a transverse direction of the recessed portion either decreases or remains the same downward.

14. The coil component according to claim 13, wherein
a dimension in the transverse direction of the plurality of recessed portions decreases downward,
each of the peripheral walls demarcating the plurality of recessed portions is inclined,
a depth of one of the recessed portions among the plurality of recessed portions is smaller than a depth of another of the recessed portions, and
an inclination angle of the peripheral wall of the one recessed portion is larger than an inclination angle of the peripheral wall of the other recessed portion.

15. The coil component according to claim 11, wherein
the base portion has
a side wall that is arranged outside of the protruding portion in a bending direction of the bent portion,
the protruding portion and the side wall overlap with each other in an overlap area in a bottom view,
the protruding portion and the side wall are in contact with each other in the overlap area,
the lower surface of the base portion is provided with a terminal recessed portion that is surrounded by a peripheral wall and the protruding surface,
the protruding portion protrudes from the protruding surface being a top wall of the terminal recessed portion and is surrounded by the peripheral wall,
a part of the peripheral wall is the side wall and is in contact with the protruding portion,
another part of the peripheral wall is arranged in a vicinity of the protruding portion and is separated from the protruding portion,
the wire-joining portion and the mounting portion are positionally displaced in a top view, and
the protruding surface of the terminal recessed portion and a bottom surface of the recessed portion are positionally displaced in a same direction as the direction of the positional displacement of the wire-joining portion and the mounting portion in a top view.

16. The coil component according to claim 15, wherein
the terminal recessed portion is arranged on an outer side in the protruding direction than a part of the recessed portion in a top view.
